(19) United States
(12) Patent Application Publication
(10) Pub. No.: US 2018/0177153 A1
(43) Pub. Date: Jun. 28, 2018

(54) Animal Drinking Assembly

(71) Applicant: Vernon Matson, Nantucket, MA (US)

(72) Inventor: Vernon Matson, Nantucket, MA (US)

(21) Appl. No.: 15/392,463

(22) Filed: Dec. 28, 2016

(51) Int. Cl. A01K 7/00; B65D 43/02; B65D 51/24

(52) U.S. Cl. CPC A01K 7/005; B65D 2543/00833; B65D 51/245; B65D 43/02

(57) ABSTRACT

An animal drinking assembly for facilitating an animal to drink during travel includes a bowl that may contain a liquid. A cover is removably attached to the bowl to retain the liquid in the bowl. The cover is selectively removed to facilitate an animal to drink the liquid in the bowl.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to drinking devices and more particularly pertains to a new drinking device for facilitating an animal to drink during travel.

### BRIEF SUMMARY OF THE INVENTION

An embodiment of the disclosure meets the needs presented above by generally comprising a bowl that may contain a liquid. A cover is removably attached to the bowl to retain the liquid in the bowl. The cover is selectively removed to facilitate an animal to drink the liquid in the bowl.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an animal drinking assembly according to an embodiment of the disclosure.

FIG. 2 is a bottom view of an embodiment of the disclosure.

FIG. 3 is a perspective view of an embodiment of the disclosure.

FIG. 4 is a perspective view of an embodiment of the disclosure showing a cover being removed.

### DETAILED DESCRIPTION OF THE INVENTION

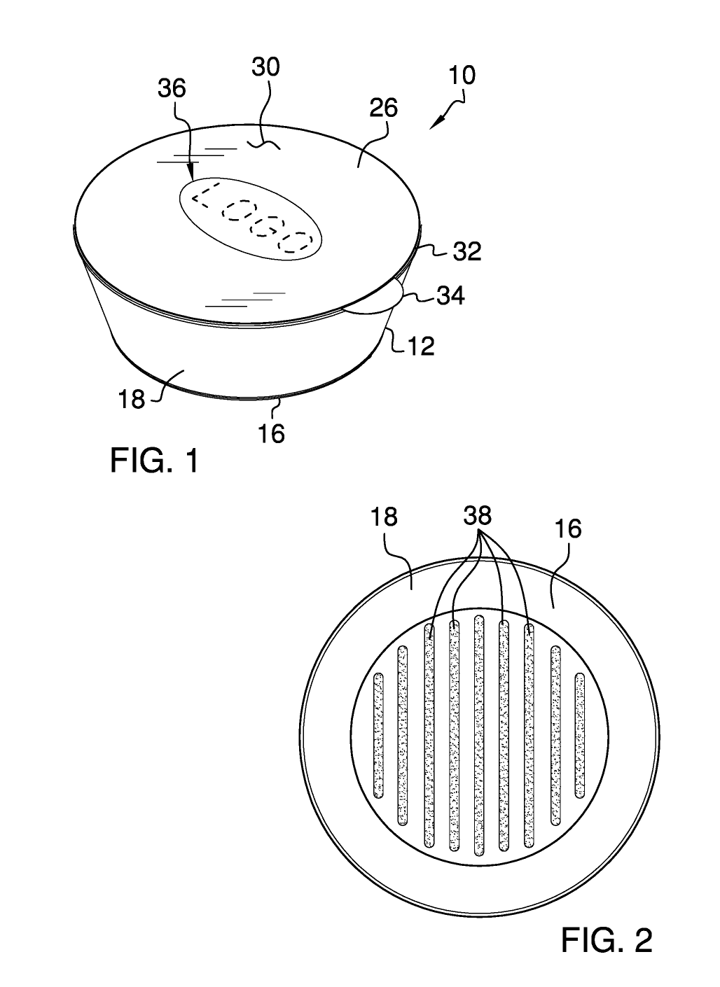

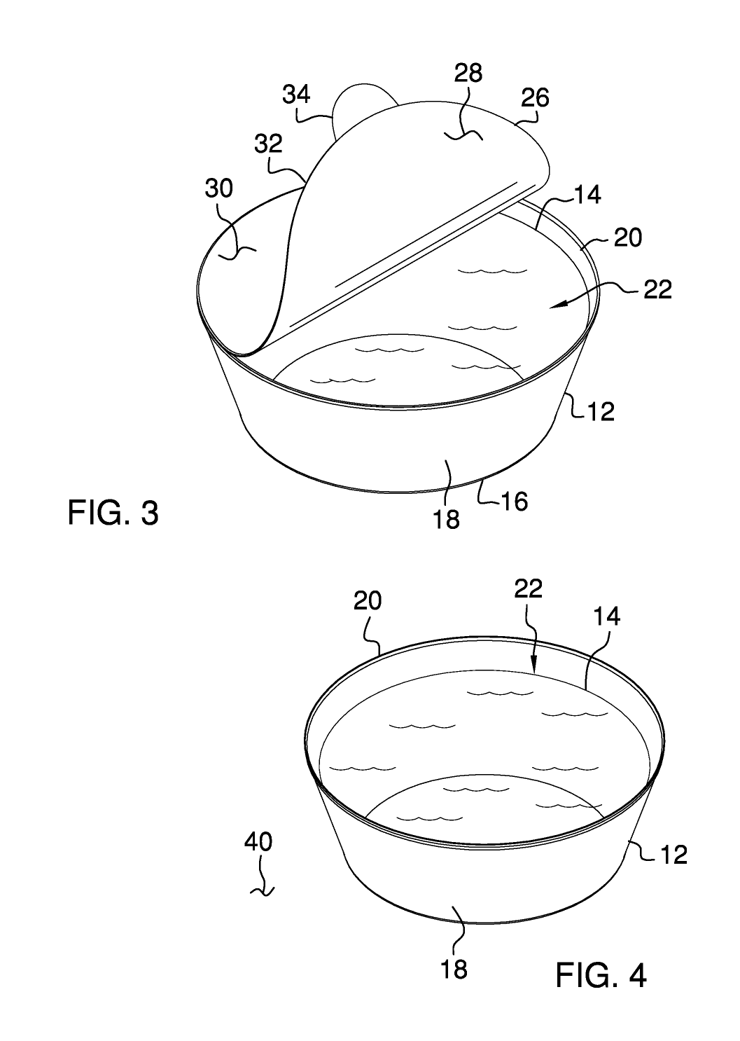

With reference now to the drawings, and in particular to FIGS. 1 through 4 thereof, a new drinking device embodying the principles and concepts of an embodiment of the disclosure and generally designated by the reference numeral 10 will be described.

As best illustrated in FIGS. 1 through 4, the animal drinking assembly 10 generally comprises a bowl 12 that may contain a liquid 14 that may be drunk by an animal. The animal may be a dog, a cat or any other domesticated animal. The liquid 14 may be water or any other drinkable liquid 14. The bowl 12 has a basal wall 16 and an outer wall 18 extending upwardly therefrom. The outer wall 18 has a distal edge 20 with respect to the basal wall 16 to define an opening 22 into the bowl 12 and the basal wall 16 has a bottom surface 24.

A cover 26 is removably attached to the bowl 12 to retain the liquid 14 in the bowl 12. The cover 26 has a first surface 28, a second surface 30 and a peripheral edge 32 extending therebetween. The first surface 28 is removably coupled to the distal edge 20 of the bowl 12. A tab 34 extends outwardly from the peripheral edge 32. The tab 34 may be gripped thereby facilitating the cover 26 to be removed from the bowl 12. The cover 26 may be adhered to the distal edge 20 of the bowl 12 or otherwise removably attached to the bowl 12. Indicia 36 may be printed on the second surface 30 and the indicia 36 may comprise a selected image or logo.

A plurality of gripping members 38 is provided and each of the gripping members 38 is coupled to the bottom surface 24 of the bowl 12. Each of the gripping members 38 may be comprised of a resiliently compressible material. In this way each of the gripping members 38 frictionally engages a support surface 40 thereby inhibiting the bowl 12 from sliding on the support surface 40. The support surface 40 may be a floor or the like.

In use, the bowl 12 is prefilled with the liquid 14 and the bowl 12 is made available for purchase in a vending machine or any other retail environment. In this way the liquid 14 is available for the animal to drink during travel. The bowl 12 is placed on the support surface 40 and the cover 26 is removed from the bow. Thus, the animal may drink the liquid 14 in the bowl 12. The bowl 12 and the cover 26 are discarded when the liquid 14 is consumed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal drinking assembly having a removable lid thereby facilitating an animal to drink, said assembly comprising:
a bowl being configured to contain a liquid; and
a cover being removably attached to said bowl wherein said cover is configured to retain the liquid in said bowl, said cover being selectively removed from said bowl wherein said bowl is configured to have an animal drink therefrom.

2. The assembly according to claim 1, wherein said bowl has a basal wall and an outer wall extending upwardly therefrom, said outer wall having a distal edge with respect to said basal wall to define an opening into said bowl, said basal wall having a bottom surface.

3. The assembly according to claim 2, wherein said cover has a first surface, a second surface and a peripheral edge extending therebetween, said first surface being removably coupled to said distal edge of said bowl, said peripheral edge having a tab extending outwardly therefrom wherein said tab is configured to be gripped thereby facilitating said cover to be removed from said bowl.

4. The assembly according to claim 2, further comprising a plurality of gripping members, each of said gripping members being coupled to said bottom surface of said bowl, each of said gripping members being configured to frictionally engage a support surface thereby inhibiting said bowl from sliding on the support surface.

5. An animal drinking assembly having a removable lid thereby facilitating an animal to drink, said assembly comprising:
a bowl being configured to contain a liquid, said bowl having a basal wall and an outer wall extending upwardly therefrom, said outer wall having a distal edge with respect to said basal wall to define an opening into said bowl, said basal wall having a bottom surface;
a cover being removably attached to said bowl wherein said cover is configured to retain the liquid in said bowl, said cover being selectively removed from said bowl wherein said bowl is configured to have an animal drink therefrom, said cover having a first surface, a second surface and a peripheral edge extending therebetween, said first surface being removably coupled to said distal edge of said bowl, said peripheral edge having a tab extending outwardly therefrom wherein said tab is configured to be gripped thereby facilitating said cover to be removed from said bowl; and
a plurality of gripping members, each of said gripping members being coupled to said bottom surface of said bowl, each of said gripping members being configured to frictionally engage a support surface thereby inhibiting said bowl from sliding on the support surface.
